(19) United States
(12) Patent Application Publication
(10) Pub. No.: US 2003/0146699 A1
(43) Pub. Date: Aug. 7, 2003

(54) AC driven plasma device for flat lamps and method of manufacture

(76) Inventor: Jun-Sei Lee, Seoul (KR)

Correspondence Address: BIRCH STEWART KOLASCH & BIRCH, PO BOX 747, FALLS CHURCH, VA, 22040-0747, US

(21) Appl. No.: 10/061,414

(22) Filed: Feb. 4, 2002

(51) Int. Cl. H01J 17/49

(52) U.S. Cl. 313/582

(57) ABSTRACT

An AC driven plasma device which has a discharge cell formed by sealing an upper plate having a front glass substrate and a lower plate having a rear glass substrate using a sealing material and which is illuminated by light, created by the plasma discharge phenomenon when an AC power supply is applied thereto which comprises providing a transparent electrode and a protective film which have a thickness of several thousand of Å units under the upper plate, and dividing the lower plate by glass partition walls into a plurality of discharge cells, a white colored fluorescent material on the side and bottom of the discharge cells, and depositing a metal electrode under the lower plate, wherein the upper and lower plates are attached by a sealing material so that the surface of the protective film on the upper plate and the discharge cells are disposed opposite to each other, and the air in the discharge cells is replaced with discharge gas.

### FIELD OF THE INVENTION

The present invention relates to an AC driven plasma device for flat lamps and to a method for its manufacturing. More particularly, the present invention is directed to an AC driven plasma device for flat lamps and to a method for its manufacture wherein the method for forming the partition wall, the structure of the dielectric layer and the fluorescent material layer is improved in order to make the manufacturing process easy and to reduce the manufacturing cost and reduce its drive voltage when it is discharged.

### BACKGROUND AND SUMMARY OF THE INVENTION

In general, Plasma is a situation in which positive charges and negative charges are mixed in a similar volume such that its electrical property is neutral. When high voltage is applied to the positive and negative electrodes in a vacuum atmosphere, the discharge gas is activated and returned to a stable state. At this time, the discharge gas is illuminated into an extensive and beautiful light, like an aurora.

The plasma device for flat lamps uses the plasma illumination phenomenon described above and it has been used as back light for LCD (Liquid Crystal Display) devices, is a flat light source for illumination, and the like.

FIG. 1 is a sectional view of a conventional plasma device for flat lamps. As shown in FIG. 1, a plasma device for flat lamps consists of an upper plate 10, a lower plate 15 which is connected to the upper plate 10 by sealing material 7, and a discharge cell 8 disposed between the upper and lower plates. The upper plate 10 is covered with a flat type of transparent electrode 2 on its front side of front glass substrate 1 and with white colored fluorescent layers 3 on its reverse side of the front glass substrate 1, which emits white colored light when the gas is discharged. Here, the front glass substrate 1 acts as a dielectric in the capacitance device, like a PDP device, since the substrate 1 is positioned under the transparent electrode 2.

Also, the lower plate 15 is sequentially covered with a metal electrode 5 formed of silver paste on the reverse glass substrate 4, a white colored dielectric layer 6 which accumulates the charge, regulates current flowing through the device when applying an alternative power supply, and reflects the white-colored light to the front glass substrate 1, and 3 wavelength white-colored fluorescent layer 3 which emits white-colored light when the gas is discharged.

The upper and lower plates 10, 15 are melted and glued using a sealing material 7, whose main component is frit glass, to form a discharge cell 8 where gas discharge occurs. The manufacturing process of the plasma device for flat lamps is finished after extracting air from the discharge cell 8 and injecting a mixed gas of Ar, He, Ne, Xe, Hg etc. into the cell 8.

Here, if the transparent electrode 2 and metal electrode 5 are applied with an alternative power supply, ultraviolet rays are generated from the discharge gas in the discharge cell 8 due to the discharge phenomenon. The white colored fluorescent material 3 is excited and the white colored visible light is emitted from the front glass substrate 1.

Conventional plasma devices for flat lamps as described above have the problems of unnecessary manufacturing process steps and costs since the white colored fluorescent materials 3 are formed on the front glass substrate 1 and the reverse glass substrate 4 in order to achieve a commercially useable level of brightness.

Also, since the thickness of the front glass substrate 1 used as a dielectric is several mm and the height of the discharge cell is below 1 mm, a high voltage of nearly 1 KeV should be applied between the two electrodes in order to generate a gas discharge.

Moreover, since the white colored dielectric material 6 and the metal electrode 5 are included in the discharge cell 8, impurities are emitted in the form of a gas which may reduce the life of the device.

Additionally, in the plasma device for flat lamps being a capacitance device having a layer structure, since drive voltage across the electrodes is applied to the discharge cell and the dielectric layer serially, the thickness of the glass substrate acting as a dielectric should be decreased and the height of the discharge cell should be increased in order to make the discharge voltage high under the low drive voltage.

Therefore, the objective of the present invention is to provide an AC driven plasma display device for flat lamps in which the ease of manufacturing and the reduction of the manufacturing cost are enhanced, the brightness of screen is improved, and the drive voltage discharge is lowered by improving the method of forming side partition walls and the structure of the dielectric and fluorescent layers.

To achieve these objectives, an AC driven plasma device for flat lamps, which has a discharge cell formed by sealing an upper plate and a lower plate using sealing material and provides illuminating light by the plasma discharge phenomenon when applying AC power thereto comprises an upper plate having a transparent electrode and a protective film which has a thickness of several thousand of Å provided under the upper plate, and a lower plate having a plurality of glass partition walls, wherein the discharge cell is divided by glass partition walls on the rear glass substrate by a cutting and/or molding process. A white-colored fluorescent material is applied to the sides and bottoms of the discharge cells, and a metal electrode is deposited under the rear glass substrate, wherein the upper and lower plates are attached using a sealing material so that the protective film deposition surface of the upper plate and the discharge cell are positioned opposite each other, and the air in the discharge cell is exhausted and replaced with discharge gas.

In accordance with the present invention, the position of the transparent electrode layer is restricted to the light transmitting area of the bottom of the front glass substrate in the upper plate, a bus electrode is peripherally provided relative to the transparent electrode, and the protective film is applied to the transparent electrode layer.

In accordance with the present invention, the height of the rear glass substrate is about 5 mm, the height of the glass partition wall is about 2-3 mm, and the distance between the partition walls is several hundreds of μm to several mm.

In accordance with the present invention, a method for manufacturing an AC driven plasma device for flat lamps having an upper plate containing a front glass substrate and a lower plate containing a rear glass substrate forming a transparent electrode layer of Indium Oxide Tin on the front glass substrate, forming a bus electrode having a desired thickness peripherally to the transparent electrode by covering the transparent electrode layer with a metal mask and depositing Cr or Al thereon, covering the bus electrode with a metal mask, and forming a magnetic oxide layer of a protective film, of desired thickness, on the transparent electrode by vacuum deposition, forming a metal electrode layer by vacuum deposition of Cr or Al on one side of the rear glass substrate having a thickness of over about 4 mm, forming a plurality of discharge cells which have a depth of 2-3 mm and a width of several hundreds of μm to several mm and applying a white-colored fluorescent material on the side and bottom of the discharge cells by preventing or spaying; and sintering the composite structure, wherein the upper and lower plates are molded and attached together using a sealing material so that the protective film of the upper plate is opposed to the white colored fluorescent material of the lower plate and opposite to the discharge cells, and replacing the air in the discharge cells with discharge gas at a desired atmospheric pressure.

### BRIEF DESCRIPTION OF THE DRAWINGS

The foregoing and other objects, features, and advantages of the present invention will be apparent from the following more particular description of the preferred embodiments as illustrated in the accompanying drawings, wherein:

FIG. 1 shows a sectional view of the AC driven plasma device for flat lamps of the conventional art; and

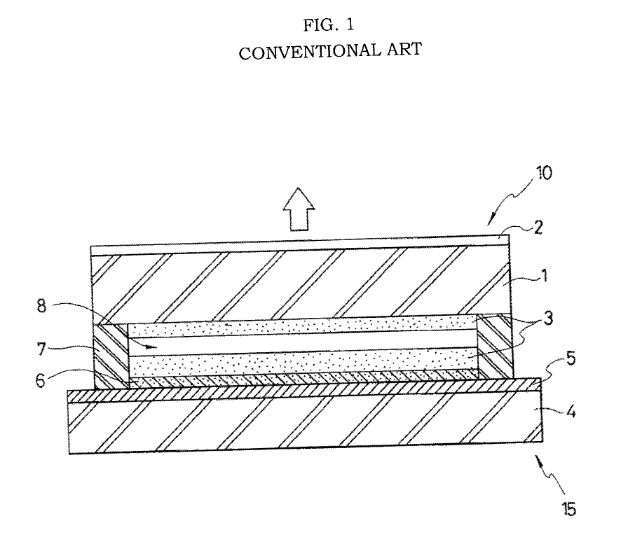

FIG. 2 shows a sectional view of the AC driven plasma device for flat lamps according to the present invention.

### DETAILED DESCRIPTION OF THE INVENTION

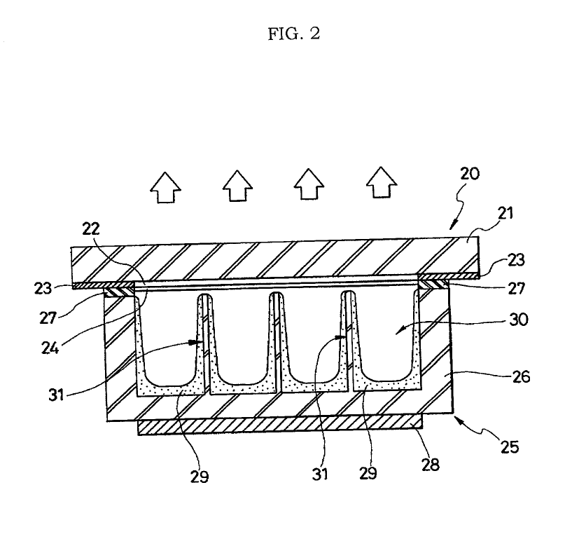

The preferred embodiment of the present invention can be described in detail in conjunction of the attached drawings in which FIG. 2 shows a sectional view of the AC driven plasma device for the flat lamps of the present invention. As shown in FIG. 2, the present invention has a structure in which the upper plate 20 and a lower plate 25 are sealed, by sealing material 27. The lower plate 25 is divided by glass partition walls 31 into plurality of discharge cells 30. A mixed gas, such as Ar, He, Ne, Xe, Hg etc. is injected into the discharge cells 30 at a desired pressure where the discharge phenomenon is generated when a power supply is applied thereto.

The upper plate 20 is provided with a transparent electrode 22 formed of In₂O₂: Sn and a bus electrode 23 formed of Cr or Al in the lower surface of the front glass substrate 21 and having a thickness of 2-3 mm in the thickness of thousands of Å. A protective film 24 of MgO is disposed under the transparent electrode 22 having a thickness in thousands of Å units.

The protective film 24 of MgO emits the secondary electron when discharge gas and then reduces the discharge voltage, and prevents the front glass substrate 20 from becoming abraded by the ions of the discharge gas.

Also, when the area of the transparent electrode 22 is increased, the resistance is also increased. So, in the deposition of the transparent electrode 22 on the lower surface of the front glass substrate 21, as shown in FIG. 2, the resistances in the electrodes are reduced by only forming the transparent electrode layer 22 on the area where the visible light penetrates and by forming bus electrodes 23 at the circumferential area, whereby the desired discharge property can be displayed.

On the other hand, the lower plate 25 includes a plurality of discharge cells 30 formed by a cutting or molding process in the upper part of the rear glass substrate 26. A metal electrode layer 28 is formed of Cr or Al having good light reflexibility in several thousands of Å, and a white colored fluorescent material 29 is provided which completely covers the sides of the glass partition walls 31 and the bottom of the discharge cells.

Since the rear glass plate 26 has a height of about 5 mm and the glass partition wall 31 and the discharge cell 30 have a height of about 3-4 mm, the discharge cell 30 is high relative to the dielectric layer and then is applied enough voltage by a low drive voltage. Since the white fluorescent material 29 is widely applied along the side of the glass partition walls 31 and the bottom groove of the discharge cell, the screen brightness of the device can be increased.

Also, since the glass partition wall (glass diaphragm) 31 acts as a support for the upper plate 20, it prevents the upper plate 20 from being distorted by atmospheric pressure in the process of evacuation of the discharge cell 30.

On the other hand, the lower plate 25 is provided with the plurality of discharge cells 30 by using the glass diaphragms or glass partition walls which are formed on the top of the rear glass substrate 26 by a cutting process or molding process. The lower surface of the rear glass substrate 26 is deposited with the metal electrode layer 28 made of chrome (Cr) or aluminum (Al) having good light reflectivity with a thousand of Å thicknesses. The side and each groove bottom of the glass diaphragm 31 is totally covered with the white fluorescent substance 29.

The height of the rear glass substrate 26 is on the order of about 5 mm. The heights of the glass diaphragms 31 and the discharge cells 30 are about 3-4 mm so that the heights of the discharge cells 30 are greater than that of the dielectric layer for applying a sufficient voltage to the discharge cell 30 even by low drive voltage. Also the white fluorescent substance 29 can be widely applied along the side and the groove bottom of the glass diaphragm 31 to increase the picture brightness of the element.

Furthermore, the glass diaphragm 31 serves to support the top plate 20 to prevent the top plate 20 from bending due to atmospheric pressure during the exhausting processing for the discharge cell 30.

The method of manufacturing a plasma device for flat lamps and its operation and effect according to the present invention will now be described.

First, in the process of manufacturing the upper plate 20, a front glass substrate 21 having thickness of about 3 mm is coated or deposited with In₂O₃: Sn by vapor deposition in a vacuum atmosphere and in a thickness of several thousands Å to form the transparent electrode 22.

The transparent electrode 22 is covered with a metal mask and is vapor deposited with Chrome (Cr) or Aluminum (Al) to form bus electrode 23 of a desired thickness at the periphery of the transparent electrode 22 on the front glass substrate 21.

Because the resistance is large when the area of the transparent electrode 22 is large, the bus electrode 23 serves to maintain a good discharge characteristic by reducing the resistance caused by the transparent electrode 22.

Also, the bus electrode 23 is totally covered with a metal mask and is vapor-deposited with MgO to form a protective film 24 of thousands of Å thickness on the transparent electrode 22.

In the process of manufacturing the lower plate, the edge of the rear glass substrate 26 having thickness of about 5 mm is covered with a metal mask and is vapor-deposited with Cr or Al having a good light reflectivity to form the metal electrode 28 having thickness of thousands of Å.

Also, the opposite rear glass substrate 26 that is not formed with the metal electrode 28 is provided with the plurality of discharge cells 30 by cutting a plurality of grooves using a sandblast method to form a glass partition walls 31 that have a width of several hundreds of microns to several mm and a height of 2-3 mm between the discharge cells, the depth of the grooves being about 2-3 mm and the distance between the grooves being several hundreds of micron to several mm. A molding method such as melting glass and then pressing it into a frame to have the shape of partition walls can be used to form the glass partition wall 31.

Also, the lower plate 25 can be manufactured by applying the white-colored fluorescent material 29 to the side of the glass partition wall 31 and the bottom of groove using a thick film printing method or an injecting method, followed by sintering.

After melting and cementing the upper plate 20 to the lower plate 25, manufactured according to the present method, the air within the discharge cell 20 is exhausted and a mixture of gas of Ar, He, Ne, Xe, Hg and the like, in the order of tens to hundreds of Torr, is injected to complete the plasma device for a plane lamp in accordance with the present invention.

In the case of applying AC voltage in the order of 300 V of 30 kHz between the transparent electrode 22 and the metal electrode 28 of the plasma device for flat lamps, ultraviolet rays are produced from the gas mixture due to the discharge phenomenon whereby the white-colored fluorescent material 29 is excited by the ultraviolet rays to obtain white-colored, visible light.

The plasma device for flat lamps in accordance with the present invention, such as described above, which utilizes the rear glass substrate 26 as a dielectric by forming the metal electrode 28 into the bottom of the rear glass substrate 26, prevents the generation of impurity gas by removing the white-colored dielectric layer 6 and the metal electrode 5 from the discharge cell. Also, a white-colored dielectric layer is not needed which reduces manufacturing cost as well as obtains a sufficient discharge voltage, even with low drive voltage by making the height of the discharge cell larger when compared to the thickness of the dielectric layer consisting of the substrate and the protective film.

Also, since the white-colored fluorescent substance 29 is totally applied to the side of the glass partition walls 31 and the bottom of the groove, thereby establishing a fluorescence area which is very large, the brightness of the device can be significantly improved more than two times. Because the upper plate 20 is supported by a plurality of internal glass partition walls 31, it can prevent the upper plate from bending due to atmospheric pressure during the exhaust process of the discharge cell.

The present invention does not limit to the above embodiment, but can be practiced through various modifications within the scope of the invention.

### EFFECT OF THE INVENTION

According to the present invention, such as described above, the white-colored dielectric and the metal electrode is removed within the discharge cell and a metal electrode is formed at the bottom of the rear glass substrate to prevent the generation of gas impurity within the discharge cell so that the life of the device can be extended as well as promoting ease of manufacturing and reduction in manufacturing costs.

Furthermore, the invention can obtain a sufficient discharge effect even in low drive voltage and can increase the picture brightness of the device, by cutting, processing or molding the rear glass substrate in order to produce a plurality of glass partition walls and a high discharge cell and by applying the white-colored fluorescent substance to the side of the glass partition wall and the bottom groove of the discharge cell in order to increase the forming area.

What is claimed is:

1. An AC driven plasma device which has a discharge cell
formed by sealing an upper plate having a front glass substrate and a lower plate having a rear glass substrate using a sealing material and which is illuminated by light, created by the plasma discharge phenomenon when an AC power supply is applied thereto which comprises:
providing a transparent electrode and a protective film which have a thickness of several thousand of Å units under the upper plate, and
dividing the lower plate by glass partition walls into a plurality of discharge cells,
a white colored fluorescent material on the side and bottom of the discharge cells, and depositing a metal electrode under the lower plate,
wherein the upper and lower plates are attached by a sealing material so that the surface of the protective film on the upper plate and the discharge cells are disposed opposite to each other, and the air in the discharge cells is replaced with discharge gas.

2. AC driven plasma device according to claim 1, wherein the transparent electrode layer is restricted to the light transmitting area of the bottom of the front glass substrate in the upper plate and a bus electrode is positioned at the remaining bottom portion of the front glass substrate, peripheral to the light transmitting area, and the protective film which is disposed on the transparent electrode layer is also restricted to the light transmitting area.

3. The AC driven plasma device according to claim 1, wherein the transparent electrode is made of Indium Oxide Tin (In₂O₃: Sn).

4. The AC driven plasma device according to claim 1, wherein the height of the rear glass substrate is about 5 mm, the height of the glass partition wall is about 2-3 mm, and the distance between the partition walls is several hundred μm to several mm.

5. The AC driven plasma device according to claim 2, wherein the bus electrode and the metal electrode are made of Cr or Al.

6. A method for manufacturing an AC driven plasma device for flat lamps having an upper plate containing a front glass substrate and a lower plate containing a rear glass substrate, which comprises:
forming a transparent electrode layer of Indium Oxide, Tin on the front glass substrate,
forming a bus electrode having a desired thickness peripherally to the transparent electrode by covering the transparent electrode layer with a metal mask and depositing Cr or Al thereon in a vacuum atmosphere,
covering the bus electrode with a metal mask and forming a Magnesium Oxide layer of a protective film, of desired thickness, on the transparent electrode by vacuum deposition,
forming a metal electrode layer by vacuum deposition of Cr or Al on one side of the rear glass substrate having a thickness of over 4 mm,
dividing the rear surface glass substrate by glass partition walls into a plurality of discharge cells which have a depth of 2-3 mm and a width of several hundreds μm to several mm, and
applying a white colored fluorescent material on the side and bottom of the discharge cells, and
sintering the composite structure, wherein the upper and lower plates are molded and attached together using a sealing material so that the protective film of the upper plate is opposite to the white colored fluorescent material of the lower plate and opposite to the discharge cells, and
replacing the air in the discharge cells with discharge gas at a desired atmospheric pressure.
